(19) United States
(12) Patent Application Publication
(10) Pub. No.: US 2016/0099464 A1
(43) Pub. Date: Apr. 7, 2016

(54) POSITIVE ACTIVE MATERIAL FOR RECHARGEABLE LITHIUM BATTERY, AND POSITIVE ACTIVE MATERIAL LAYER AND RECHARGEABLE LITHIUM BATTERY INCLUDING SAME

(71) Applicant: SAMSUNG SDI CO., LTD., Yongin-si (KR)

(72) Inventors: Yuki Takei, Yokohama-shi (JP); Masatsugu Nakano, Yokohama-shi (JP); Heidy Visbal, Yokohama-shi (JP)

(21) Appl. No.: 14/871,905

(22) Filed: Sep. 30, 2015

(30) Foreign Application Priority Data
Oct. 1, 2014 (JP) 2014-203064
Sep. 7, 2015 (KR) 10-2015-0126310

(51) Int. Cl. H01M 4/36; H01M 4/04; H01M 10/0525; H01M 4/485; H01M 4/525

(52) U.S. Cl. CPC H01M 4/366; H01M 4/485; H01M 4/525; H01M 10/0525; H01M 4/0428; H01M 4/0423

(57) ABSTRACT

A positive active material for a rechargeable lithium battery includes a lithium nickel-based oxide particle and a coating layer surrounding the lithium nickel-based oxide particle, the coating layer including diamond-like carbon. The lithium nickel-based oxide particle includes lithium and a nickel-containing metal. The nickel-containing metal includes about 60 atom % or greater of nickel based on the total atomic amount of the nickel-containing metal. An SP²/SP³ ratio of the coating layer is about 50/50 to about 60/40. A positive active material layer and a rechargeable lithium battery including the same are provided.

### CROSS-REFERENCE TO RELATED APPLICATIONS

This application claims priority to and the benefit of Japanese Application No. 2014-203064, filed in the Japanese Patent Office on Oct. 1, 2014; and Korean Patent Application No. 10-2015-0126310, filed in the Korean Intellectual Property Office on Sep. 7, 2015, the entire contents of both of which are incorporated herein by reference.

### BACKGROUND

1. Field

A positive active material for a rechargeable lithium battery, and a positive active material layer and a rechargeable lithium battery including the same are disclosed.

2. Description of the Related Art

A lithium transition metal composite oxide including nickel (Ni) as a main component (hereinafter, referred to as a “highly nickel-based composite oxide”) has recently gained lots of attention as a positive active material realizing relatively high potential and high capacity.

However, a rechargeable lithium ion battery including the highly nickel-based composite oxide as a positive active material has a problem of cycle-life deterioration, particularly at a high temperature.

It is deemed that the cycle-life deterioration problem may be caused by the easy oxidation of nickel located on the surface of the highly nickel-based composite oxide particles. In other words, nickel on the surface of the highly nickel-based composite oxide particles is easily oxidized at a high temperature and during a full charge; and the oxidized nickel has a rock salt structure such as NiO or the like, which does not contribute to the intercalation/deintercalation of Li. Accordingly, the cycle-life of the rechargeable lithium ion battery is deteriorated.

In addition, the cycle-life deterioration problem may be caused by a reaction of the highly nickel-based composite oxide with moisture or carbon dioxide in the air. In other word, the highly nickel-based composite oxide reacts with moisture or carbon dioxide in the air, and thus generates impurities such as hydroxide lithium, carbonate lithium and/or the like, which deteriorates the cycle-life of the rechargeable lithium ion battery. Furthermore, carbonate lithium is further decomposed and generates carbon dioxide, and this carbon dioxide may possibly increase the internal pressure of the rechargeable lithium ion battery.

In this way, when the highly nickel-based composite oxide is utilized as a positive active material for a rechargeable lithium ion battery, various side reactions occur and deteriorate its cycle-life. In addition, it is found that the highly nickel-based composite oxide utilized as a positive active material decomposes an electrolyte solution.

On the other hand, Japanese Patent Laid-open Publication No. 2011-71084 discloses a technology of coating a positive active material with diamond-like carbon (DLC), the entire content of which is incorporated herein by reference. However, this patent reference does not disclose the use of the highly nickel-based composite oxide as a positive active material. In addition, the patent reference does not restrict the structure of the DLC.

### SUMMARY

An aspect according to one or more embodiments of the present invention is directed toward a positive active material for a rechargeable lithium battery suppressed from a side reaction and including a highly nickel-based composite oxide, and improving cycle-life characteristics of the rechargeable lithium battery utilizing the highly nickel-based composite oxide.

Another aspect according to one or more embodiments of the present invention is directed toward a positive active material layer including the positive active material.

Yet another aspect according to one or more embodiments of the present invention is directed toward a rechargeable lithium battery including the positive active material layer.

According to one embodiment of the present invention, a positive active material for a rechargeable lithium battery includes a lithium nickel-based oxide particle; and a coating layer surrounding the lithium nickel-based oxide particle, the coating layer including diamond-like carbon (DLC), wherein the lithium nickel-based oxide particle includes lithium, and a nickel-containing metal, and the nickel-containing metal includes greater than or equal to about 60 atom % of nickel based on a total atomic amount of the nickel-containing metal, and the coating layer has an SP²/SP³ ratio ranging from about 50/50 to about 60/40.

A thickness of the coating layer may be about 2 nm to about 20 nm.

The lithium nickel-based oxide particle may include about 80 atom % or greater of nickel based on the total atomic amount of the nickel-containing metal.

The coating layer may include about 2 atom % to about 30 atom % of hydrogen based on a total atomic amount of the coating layer.

The lithium nickel-based oxide particle may be represented by Chemical Formula 1.

LiₐNiₓCo_{y}M_{z}O₂ Chemical Formula 1

In Chemical Formula 1,

M is at least one metal selected from aluminum (Al), manganese (Mn), chromium (Cr), iron (Fe), vanadium (V), magnesium (Mg), titanium (Ti), zirconium (Zr), niobium (Nb), molybdenum (Mo), tungsten (W), copper (Cu), zinc (Zn), gallium (Ga), indium (In), tin (Sn), lanthanum (La), and cerium (Ce);
0.2≦a≦1.2, 0.8≦x<1, 0<y≦0.2, 0≦z≦0.1, and x+y+z=1.

The coating layer may be formed by a plasma chemical vapor growth (CVD) method, a physical vapor growth (PVD) method, a plasma based ion implantation (PBII) method or a combination thereof on a surface of the lithium nickel-based oxide particle.

According to another embodiment of the present invention, a positive active material layer for a rechargeable lithium battery includes the positive active material.

According to yet another embodiment of the present invention, a rechargeable lithium battery includes the positive active material layer.

Other embodiments are included in the following detailed description.

According to some embodiments, the cycle-life characteristics of a rechargeable lithium battery utilizing a highly nickel-based composite oxide may be improved by suppressing the side reaction of the highly nickel-based composite oxide.

### BRIEF DESCRIPTION OF THE DRAWINGS

FIG. 1 is a schematic cross-sectional view showing the structure of a rechargeable lithium battery according to one embodiment;

FIG. 2 is a schematic cross-sectional view showing the structure of a positive active material for a rechargeable lithium battery according to one embodiment;

FIGS. 3 and 4 are transmission electron microscope (TEM) photographs showing a positive active material according to Example 1;

FIGS. 5 and 6 are graphs each showing the measurement results of the positive active material according to Example 1 utilizing electron energy loss spectroscopy (EELS);

FIG. 7 is a graph showing the measurement results regarding the coating layer in the positive active material according to Example 1 utilizing High Resolution Rutherford Backscattering Spectrometry (HR-RBS) and High Resolution Elastic Recoil Detection Analysis (HR-ERDA);

FIG. 8 is a graph showing capacity relative to a rate of charging rechargeable lithium battery cells according to Examples 1 and 2 and Comparative Example 1;

FIG. 9 is a graph showing a capacity retention relative to a rate of charging the rechargeable lithium battery cells according to Examples 1 and 2 and Comparative Example 1; and

FIGS. 10 to 13 are graphs each showing X-ray photoelectron spectroscopy (XPS) measurement results regarding the surface of positive active materials.

### DETAILED DESCRIPTION

Hereinafter, embodiments are described in more detail. However, these embodiments are examples, and this disclosure is not limited thereto.

As used herein, when specific definition is not otherwise provided, it will be understood that when an element such as a layer, film, region, or substrate is referred to as being “on” another element, it can be directly on the other element or intervening elements may also be present.

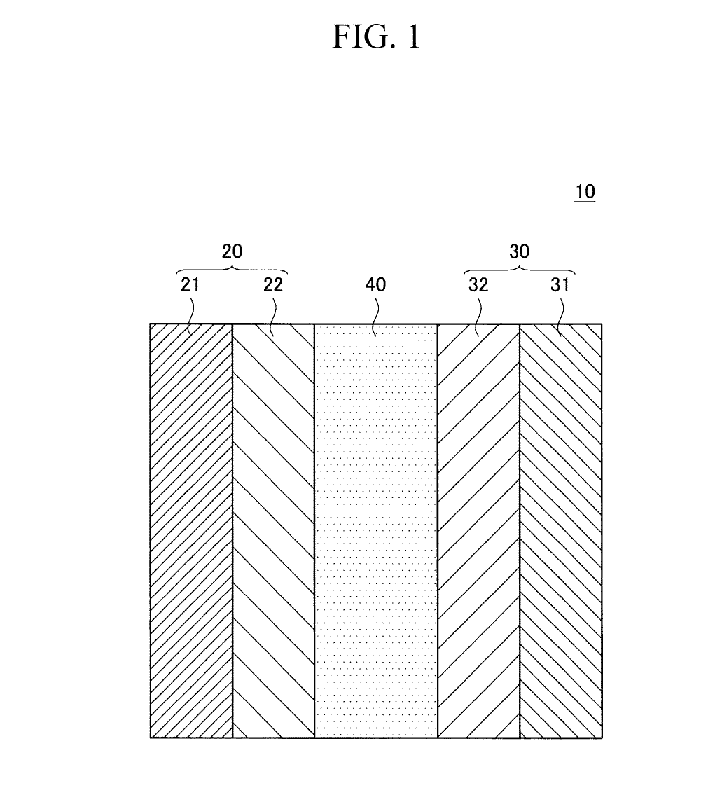

Hereinafter, a rechargeable lithium battery according to one embodiment is described referring to FIG. 1.

FIG. 1 is a schematic cross-sectional view showing the structure of a rechargeable lithium battery according to one embodiment.

Referring to FIG. 1, the rechargeable lithium battery 10 includes a positive electrode 20, a negative electrode 30, and a separator layer 40. The rechargeable lithium ion battery 10 has no particular limit to its shape, and may have any suitable shape such as a cylinder shape, a prism laminate shape, a button shape, and/or the like.

The positive electrode 20 includes a current collector 21 and a positive active material layer 22 formed on the current collector 21.

The current collector 21 may be aluminum, and/or the like, but the current collector 21 is not limited thereto.

The positive active material layer 22 includes a positive active material, and further includes at least one of a conductive material and a binder.

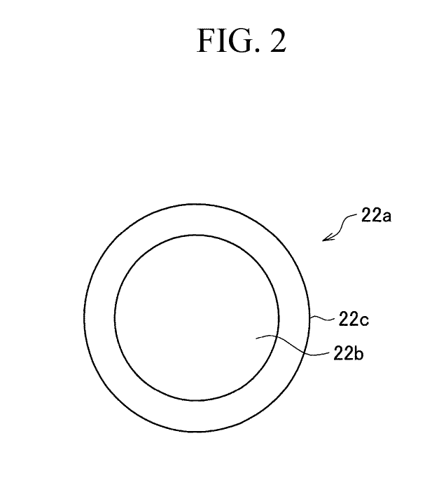

Hereinafter, the positive active material is illustrated referring to FIG. 2. However, the positive active material is not limited thereto.

FIG. 2 is a schematic cross-sectional view showing the structure of a positive active material for a rechargeable lithium battery according to one embodiment.

Referring to FIG. 2, the positive active material 22a may include a lithium nickel-based oxide particle 22b and a coating layer 22c surrounding the lithium nickel-based oxide particle 22b.

The lithium nickel-based oxide particle 22b includes lithium, and a nickel-containing metal (e.g., a nickel-containing metal including nickel and at least one other metal element), wherein nickel may be included in an amount of greater than or equal to about 60 atom %, for example, greater than or equal to about 80 atom %, based on the total atomic amount of the nickel-containing metal (e.g., based on the total atomic amount of nickel and the at least one other metal element). In other words, the lithium nickel-based oxide particle 22b may be a highly nickel-based composite oxide.

The lithium nickel-based oxide particle may be, for example, represented by Chemical Formula 1.

LiₐNiₓCo_{y}M_{z}O₂ Chemical Formula 1

In Chemical Formula 1,

Ni, Co and M together are referred to as the nickel-containing metal. M is at least one metal selected from aluminum (Al), manganese (Mn), chromium (Cr), iron (Fe), vanadium (V), magnesium (Mg), titanium (Ti), zirconium (Zr), niobium (Nb), molybdenum (Mo), tungsten (W), copper (Cu), zinc (Zn), gallium (Ga), indium (In), tin (Sn), lanthanum (La), and cerium (Ce);
0.2≦a≦1.2, 0.8≦x<1, 0<y≦0.2, 0≦z≦0.1, and x+y+z=1.

The coating layer 22c surrounds the lithium nickel-based oxide particle 22b and may include diamond-like carbon (DLC).

The positive active material may be suppressed from a side reaction to a different degree depending on the structure of the diamond-like carbon (DLC). For example, the side reaction may have a correlation with the thickness of the coating layer 22c, the SP²/SP³ ratio of the DLC, hydrogen atom % in the DLC, and/or the like.

In one embodiment, the coating layer may be about 2 nm to about 20 nm thick, for example, about 2.5 nm to about 20 nm thick, or, about 2.5 nm to about 5.5 nm thick. When the coating layer has a thickness within the above ranges, the positive active material, for example, the highly nickel-based composite oxide, may be suppressed from a side reaction, and furthermore, may improve cycle-life characteristics of a rechargeable lithium battery including the coating layer.

The thickness of the coating layer may be calculated utilizing the following method. A set number (e.g., a couple) of positive active materials is sampled, and the average thickness of a coating layer per each sampled positive active material particle is calculated. For example, a set number (e.g., a couple) of measuring points on the coating layer in one positive active material particle is set, and the thicknesses at the measuring points are measured and then, arithmetically averaged. Subsequently, the average thickness per each particle is calculated and averaged to obtain the thickness of a coating layer. Herein, a thickness at each measuring point may be measured utilizing a transmission electron microscope (TEM).

In one embodiment, the coating layer may have an SP²/SP³ ratio ranging from about 50/50 to about 60/40, for example, about 55/45 to about 60/40. When the coating layer has an SP²/SP³ ratio within the above ranges, the positive active material may be suppressed from a side reaction, and furthermore, may improve cycle-life characteristics of a rechargeable lithium battery including the coating layer.

The SP²/SP³ ratio of the coating layer is a mole ratio of an SP² carbon atom (a carbon atom having an SP² orbit) and an SP³ carbon atom (a carbon atom having an SP³ orbit) in the coating layer. The SP² carbon atom contributes to conductivity of the diamond-like carbon (DLC), and the SP³ carbon atom contributes to oxidation resistance and abrasion resistance of the diamond-like carbon (DLC).

The SP²/SP³ ratio of the coating layer may be calculated utilizing the following method. A set number (e.g., a couple) of positive active material particles is sampled, and the average SP²/SP³ ratio of the coating layer of each positive active material particle is calculated. For example, an average SP²/SP³ ratio is obtained by setting a set number (e.g., a couple) of measuring regions on the coating layer of one positive active material particle, calculating SP²/SP³ ratios in the measuring regions, and then, arithmetically averaging them. Subsequently, the average SP²/SP³ ratios of the positive active material particles are arithmetically averaged to calculate an average SP²/SP³ ratio among the particles. Herein, an SP²/SP³ ratio in each measuring region is measured by electronic energy loss spectroscopy (EELS).

The coating layer may include hydrogen. In one embodiment, the hydrogen may be included in a range of about 2 atom % to about 30 atom %, for example, about 2 atom % to about 24 atom %, based on the total atomic amount included in the coating layer. When the coating layer includes hydrogen within the above ranges, the positive active material may be much suppressed from a side reaction, and may further improve cycle-life characteristics of a rechargeable lithium battery.

The atom % of hydrogen included in the coating layer may be measured by both of High Resolution Rutherford Backscattering Spectrometry (HR-RBS) and High Resolution Elastic Recoil Detection Analysis (HR-ERDA). During formation of the coating layer, the deposition of diamond-like carbon (DLC) on lithium nickel-based oxide particles utilizing a plasma chemical vapor growth (CVD) method and/or a physical vapor growth (PVD) method is performed by depositing the diamond-like carbon (DLC) on the lithium nickel-based oxide particles and a silicon substrate, where the silicon substrate includes no hydrogen.

Hereinafter, a method of manufacturing the positive active material is illustrated.

A method of manufacturing lithium nickel-based oxide particles has no particular limit but may include, for example, a co-precipitation method.

Hereinafter, the co-precipitation method of manufacturing the lithium nickel-based oxide particles is illustrated as one example, but a mixing amount, a raw material, and/or the like are not limited thereto.

First, nickel sulfate 6 hydrate (NiSO₄.6H₂O), cobalt sulfate 5 hydrate (CoSO₄.5H₂O), and a metal (M)-containing compound are dissolved in ion exchange water (e.g., water treated through an ion exchange process), thus preparing a mixed aqueous solution. Herein, the total weight of the nickel sulfate 6 hydrate, the cobalt sulfate 5 hydrate, and the metal (M)-containing compound may be, for example, about 20 wt % based on the total weight of the mixed aqueous solution. In addition, the nickel sulfate 6 hydrate, the cobalt sulfate 5 hydrate, and the metal (M)-containing compound may be mixed in a desired mole ratio among Ni, Co, and M. On the other hand, the mole ratio of each element is determined by the composition of a lithium nickel-based oxide, and, for example, LiNi_{0.8}Co_{0.15}Al_{0.05}O₂ may be prepared in a mole ratio of 80:15:5=Ni:Co:Al.

In the metal (M)-containing compound, the metal element (M) may be at least one metal selected from aluminum (Al), manganese (Mn), chromium (Cr), iron (Fe), vanadium (V), magnesium (Mg), titanium (Ti), zirconium (Zr), niobium (Nb), molybdenum (Mo), tungsten (W), copper (Cu), zinc (Zn), gallium (Ga), indium (In), tin (Sn), lanthanum (La), and cerium (Ce). Examples of the metal (M)-containing compound may be various salts such as sulfate and/or nitrate of a metal element M and/or the like, an oxide, a hydroxide, and/or the like.

In addition, a set or predetermined amount, for example, 500 ml of ion exchange water is injected into a reaction layer (e.g., a reactor such as a flask for co-precipitation of the hydroxide salt of each of the metal elements) and then, maintained at 50° C. Hereinafter, an aqueous solution in the reaction layer is referred to as a reaction layer aqueous solution. Subsequently, the ion exchange water is bubbled by inert gas such as nitrogen and/or the like to remove oxygen dissolved therein. Then, the above mixed aqueous solution is added to the ion exchange water in a dropwise fashion, while the ion exchange water in the reaction layer is agitated and maintained at 50° C. In addition, a saturated NaOH aqueous solution in an excessive amount regarding Ni, Co and Al in the mixed aqueous solution (e.g., the mole amount of NaOH is greater than the sum of the mole amount of Ni, Co and Al in the mixed aqueous solution) is added to the ion exchange water. Meanwhile, the reaction layer aqueous solution is maintained at a pH of 11.5 and 50° C. during the addition. The mixed aqueous solution and the saturated NaOH aqueous solution are, for example, added at a speed of about 3 ml/min for about 10 hours, but the speed and duration are not limited thereto. Accordingly, a hydroxide salt of each of the metal elements (e.g., a hydroxide salt of each of Ni, Co and Al) is co-precipitated.

Next, the resultant of the above reaction is solid-liquid separated, for example, absorption-filtered to separate the co-precipitated hydroxide salt from the reaction layer aqueous solution, and the co-precipitated hydroxide salt is cleaned (e.g., rinsed) with ion exchange water. Subsequently, the co-precipitated hydroxide salt is, for example, vacuum-dried at about 100° C. for about 10 hours.

Subsequently, the dry co-precipitated hydroxide salt is ground with a mortar and a pestle for a set number (e.g., a couple) of minutes to obtain a dry powder, and the dry powder is mixed with a lithium hydroxide (LiOH) to obtain a mixed powder. Herein, a mole ratio between Li and Ni, Co, and M (Ni+Co+M=Me) is determined according to the composition of a lithium nickel-based oxide. For example, LiNi_{0.8}Co_{0.15}Al_{0.05}O₂ is prepared in a mole ratio of about 1:1 between Li and Me.

Subsequently, the mixed powder is fired, thereby preparing the lithium nickel-based oxide particle. Nickel atom in the mixed powder is easily reduced and thus may be fired under an oxidative atmosphere. The oxidative atmosphere may be, for example, an oxygen atmosphere. The firing time and firing temperature may be appropriately adjusted and performed, for example, at about 700° C. to about 800° C. for about 10 hours.

Subsequently, the lithium nickel-based oxide particle is coated with diamond-like carbon (DLC) to form a coating layer on the surface.

The DLC coating may be performed, for example, utilizing a plasma chemical vapor growth (CVD) method, a physical vapor growth (PVD) method, a plasma based ion implantation (PBII) method, or a combination thereof. Among these methods, the plasma chemical vapor growth (CVD) method and/or the physical vapor grown (PVD) method may be usefully applied, and the coating methods may be efficiently utilized to deposit DLC on a powder such as lithium nickel-based oxide particles and to easily adjust the thickness, SP²/SP³ ratio, and hydrogen atom content of the coating layer.

Hereinafter, one example of forming a coating layer utilizing the plasma chemical vapor growth (CVD) method is illustrated.

A holder on which the lithium nickel-based oxide particles are laid down is set in a chamber (e.g., a CVD chamber) and then, ion impact-treated. Subsequently, argon gas (carrier gas) and raw material gas are introduced into the chamber, and the raw material gas is made into the plasma state and reacted in a gas phase. Then, DLC produced through this reaction is deposited on the surface of the lithium nickel-based oxide particle to form a coating layer thereon.

In the plasma chemical vapor growth (CVD) method, the SP²/SP³ ratio of the coating layer may be adjusted by controlling the partial pressure of the raw material gas (a flow rate ratio between the carrier gas and the raw material gas). For example, the SP²/SP³ ratio may be increased by increasing the partial pressure of the raw material gas. In addition, the atom % of hydrogen atoms in the DLC may be adjusted by changing the raw material gas (e.g., a kind of the raw material gas, e.g., selecting the raw material gas according to the ratio of hydrogen atoms in the raw material gas molecule). In other words, as the ratio of hydrogen atoms in the raw material gas molecule is higher, the atom % of hydrogen atoms is increased in the DLC. The raw material gas may be, for example, methane, ethylene, acetylene, benzene, and/or the like.

In addition, the thickness of the coating layer may be adjusted by controlling the treatment time.

Hereinafter, one example of forming a coating layer utilizing the physical vapor grown (PVD) method is illustrated.

A holder on which lithium nickel-based oxide particles are laid down is set in a chamber (e.g., a PVD chamber), and graphite as a target is introduced into the chamber. Subsequently, carbon atoms are removed from the graphite by radiating an ion beam onto the graphite or exposing the graphite to an arc discharge, a glow discharge, and/or the like. The removed carbon atoms are deposited on the surface of the lithium nickel-based oxide particles to deposit DLC and thus form a coating layer.

The physical vapor grown (PVD) method may form a coating layer including no hydrogen and simultaneously being more graphitic, that is, a coating layer having a high SP²/SP³ ratio may be obtained utilizing a sputtering phenomenon from a graphite evaporation source by argon ions.

On the other hand, a DLC coating layer may be grown by simultaneously flowing hydrocarbon gas during the sputtering when a plasma CVD method is utilized with the physical vapor grown (PVD) method. Herein, the formed coating layer includes hydrogen. The atom % of hydrogen in the coating layer may be adjusted by changing a kind of hydrocarbon gas (based on a ratio of hydrogen atoms in a molecule).

The hydrocarbon gas may be, for example, methane, ethylene, acetylene, benzene, and/or the like.

In addition, the coating layer may be formed at a faster speed by radiating carbon instantly sublimated•ionized by an arc discharge onto a substrate applied by a set or predetermined bias voltage in a vacuum vessel, and as a result, a coating layer close to diamond, that is, a coating layer having a low SP²/SP³ ratio, may be formed. Furthermore, the thickness of the coating layer may be adjusted by controlling the treatment time.

The content (e.g., the amount) of the positive active material in a positive active material layer is not particularly limited but may be any suitable content applicable to a positive active material layer for a rechargeable lithium battery.

The conductive material may be, for example, carbon black (such as ketjen black, acetylene black, and/or the like), natural graphite, artificial graphite, and/or the like, but may be any suitable one in order to improve the conductivity of a positive electrode.

The conductive material has no particularly limited content (e.g., amount) but may be included in any suitable content applied to a positive active material layer for a rechargeable lithium battery.

The binder may be, for example, polyvinylidene fluoride, ethylene-propylene-diene terpolymer, styrene-butadiene rubber, acrylonitrile-butadiene rubber, fluorine rubber, polyvinylacetate, polymethylmethacrylate, polyethylene, nitrocellulose and/or the like. But the binder is not limited thereto and may be any suitable material that suitably binds the positive active material and the conductive material on the current collector.

The binder has no particularly limited content (e.g., amount) but may be included in any suitable content applied to a positive active material layer for a rechargeable lithium battery.

The positive electrode 20 may be manufactured as follows. First, the above positive active material, a conductive material, and a binder are mixed in a desired ratio, and then dispersed into an organic solvent (such as N-methyl-2-pyrrolidone or the like), thus preparing a slurry. Subsequently, the slurry is coated on a current collector 21 and dried, thereby forming a positive active material layer 22. Herein, the coating method is not particularly limited but may be performed, for example, utilizing a knife coater method, a gravure coater method, and/or the like. Subsequently, the positive active material layer 22 is compressed to have a desired thickness with a compressor to complete the manufacturing of the positive electrode 20. The positive active material layer 22 has no particularly limited thickness but may have any suitable thickness that a positive active material layer for a rechargeable lithium battery may have.

The coating process of the positive active material 22a on the current collector may be performed at a dew point temperature of −40° C. (at which a moisture content is small) in a dry environment. When moisture and/or the like is attached to the positive active material particle, LiOH, Li₂CO₃, and/or the like on the surface of the positive active material may react with the moisture and generate gas during storage at a high temperature, but this possibility may be reduced or prevented when the coating process is performed under the above environment.

The negative electrode 30 includes a current collector 31 and a negative active material layer 32 formed on the current collector 31.

The current collector 31 may include, for example, copper (Cu), nickel (Ni), and/or the like.

The negative active material layer 32 may be any suitable negative active material layer utilized for a rechargeable lithium battery. For example, the negative active material layer 32 may include a negative active material and additionally, a binder.

The negative active material may be one selected from a carbon-based material, a silicon-based material, a tin-based material, a lithium metal oxide, a metal lithium, and the like, or a mixture thereof (e.g., a mixture of two or more thereof, e.g, a mixture of more than two thereof). The carbon-based material may be, for example, a graphite-based material such as artificial graphite, natural graphite, a mixture of artificial graphite and natural graphite, natural graphite coated with artificial graphite, and/or the like. The silicon-based material may be, for example, silicon, silicon oxide, a silicon-containing alloy, a mixture of the graphite-based material and the foregoing material, and/or the like. The silicon oxide may be represented by SiOₓ (0<x≦2). The silicon-containing alloy includes silicon in the largest amount among all the metal elements based on the total amount of the alloy and for example, may be a Si—Al—Fe alloy and/or the like. The tin-based material may include, for example, tin, a tin oxide, a tin-containing alloy, their mixture with a graphite-based material, and/or the like. The lithium metal oxide may include, for example, a titanium oxide compound such as Li₄Ti₅O₁₂ and/or the like, and/or the like. According to one embodiment, when graphite among these materials is utilized, cycle-life characteristics of a rechargeable lithium battery may be further improved.

The binder has no particular limit and may be the same as a binder utilized in the positive electrode.

The negative active material and the binder may be combined in a weight ratio utilized in a related art rechargeable lithium battery without a particular limit.

The negative electrode 30 may be manufactured as follows. The negative active material and the binder are mixed in a desired ratio and then, dispersed into an organic solvent such as N-methyl-2-pyrrolidone and/or the like, thus preparing a slurry. Subsequently, the slurry is coated on a current collector 31 and dried, thereby forming a negative active material layer 32 thereon. Then, the negative active material layer 32 is compressed to have a desired thickness with a compressor, thus manufacturing a negative electrode 30. The negative active material layer 32 has no particularly limited thickness but may have any suitable thickness that a negative active material layer for a rechargeable lithium battery may have. In addition, when metal lithium is utilized as the negative active material layer 32, a metal lithium foil may be overlapped with the current collector 31.

The separator layer 40 may include a separator and an electrolyte solution.

The separator is not particularly limited, but may be any suitable separator of a rechargeable lithium battery. For example, the separator may include a porous layer or a non-woven fabric or the like having excellent high-rate discharge performance, which may be utilized as a single or a combination thereof (e.g., utilized as a single layer or multiple layers).

For example, a substrate of a fabric panel of the separator (e.g., a separator substrate) may be, for example, a polyolefin-based resin, a polyester-based resin, polyvinylidene fluoride (PVDF), a vinylidenefluoride-hexafluoropropylene copolymer, a vinylidenefluoride-perfluorovinylether copolymer, a vinylidenefluoride-tetrafluoroethylene copolymer, a vinylidenefluoride-trifluoroethylene copolymer, a vinylidenefluoride-fluoroethylene copolymer, a vinylidenefluoride-hexafluoroacetone copolymer, a vinylidenefluoride-ethylene copolymer, a vinylidenefluoride-propylene copolymer, a vinylidenefluoride-trifluoropropylene copolymer, a vinylidenefluoride-tetrafluoroethylene-hexafluoropropylene copolymer, a vinylidenefluoride-ethylene-tetrafluoroethylene copolymer, and/or the like. The polyolefin-based resin may be, for example, polyethylene, polypropylene, and/or the like, and the polyester-based resin may be, for example, polyethylene terephthalate, polybutylene terephthalate, and/or the like.

The separator has no particularly limited porosity but may have any suitable porosity that a separator for a rechargeable lithium battery may have.

In addition, the separator may include a coating layer including an inorganic filler and the coating layer may be formed on at least one side of the separator substrate. The inorganic filler may include Al₂O₃, Mg(OH)₂, SiO₂, and/or the like. The coating layer including the inorganic filler may reduce or prevent a direct contact between the positive electrode and the separator substrate and also, may reduce or prevent the oxidation and decomposition of an electrolyte solution on the surface of the positive electrode when stored at a high temperature, and suppress the generation of gas as a decomposition product of the electrolyte solution.

The coating layer including the inorganic filler may be formed on at least one side or on both sides of the separator substrate. When the coating layer is formed at least on the side of the separator substrate toward (e.g., facing) the positive electrode, the positive electrode may be reduced or prevented from directly contacting the electrolyte solution.

On the other hand, the coating layer including the inorganic filler is not limitedly to be formed on the separator but may be formed on the positive electrode. When the coating layer including the inorganic filler is formed on both sides of the positive electrode, the positive electrode may be reduced or prevented from directly contacting the separator.

In addition, the coating layer including the inorganic filler may be formed on both the separator and the positive electrode.

The coating layer including the inorganic filler may further include a binder such as polyvinylidene fluoride and/or the like.

The non-aqueous electrolyte has a composition that an electrolytic salt is contained (e.g., dissolved) in a non-aqueous solvent.

The non-aqueous solvent may be, for example, cyclic carbonate esters (such as propylene carbonate, ethylene carbonate, butylene carbonate, chloroethylene carbonate, vinylene carbonate, and/or the like); linear carbonates (such as dimethyl carbonate, diethyl carbonate, ethylmethyl carbonate, and/or the like); cyclic esters (such as γ-butyrolactone, γ-valerolactone, and/or the like); linear esters (such as methyl formate, methyl acetate, butyric acid methyl, and/or the like); tetrahydrofuran or a derivative thereof; ethers (such as 1,3-dioxane, 1,4-dioxane, 1,2-dimethoxy ethane, 1,4-dibutoxyethane, methyl diglyme, and/or the like); nitriles (such as acetonitrile, benzonitrile, and/or the like); dioxolane or a derivative thereof; ethylene sulfide, sulfolane, sultone or a derivative thereof, which may be utilized singularly or as a mixture of two or more, without any particular limitations.

The electrolytic salt may be, for example, an inorganic ion salt including lithium (Li), sodium (Na) or potassium (K) (such as LiClO₄, LiBF₄, LiAsF₆, LiPF₆, LiPF₆₋ₓ(CₙF₂ₙ₊₁)ₓ (1<x<6, n=1 or 2), LiSCN, LiBr, LiI, Li₂SO₄, Li₂B₁₀Cl₁₀, NaClO₄, NaI, NaSCN, NaBr, KClO₄, KSCN, and/or the like); an organic ion salt (such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₉)₄NI, (C₂H₅)₄N-maleate, (C₂H₅)₄N-benzoate, (C₂H₅)₄N-phthalate, stearyl sulfate, lithium octyl sulfate, lithium dodecylbenzene sulphonate, etc.,), and/or the like, which may be utilized singularly or as a mixture of two or more.

A concentration of the electrolytic salt is not particularly limited, and may be, for example, about 0.5 to about 2.0 mol/L.

Hereinafter, a method of manufacturing a rechargeable lithium battery 10 is described.

The separator is disposed between the positive electrode 20 and the negative electrode 30 to manufacture an electrode structure. The electrode structure is processed into a desired shape, for example, cylindrical, prismatic, laminate, and/or button shape, and the resultant is inserted into a shaped case. Subsequently, the non-aqueous electrolyte is injected into the shaped case, and the electrolyte solution is impregnated into each pore of the separator to manufacture a rechargeable lithium battery.

Hereinafter, the embodiments are illustrated in more detail with reference to examples. However, these examples are exemplary, and the present disclosure is not limited thereto. Furthermore, what is not described in this disclosure may be sufficiently understood by those who have knowledge in this field and will not be illustrated here.

### Manufacture of Lithium Nickel-Based Oxide Particle 22b

### Preparation Example 1

Nickel sulfate 6 hydrate (NiSO₄.6H₂O), cobalt sulfate 5 hydrate (CoSO₄.5H₂O), and aluminum nitrate (Al(NO₃)₃) were dissolved in ion exchange water, thereby preparing a mixed aqueous solution. Herein, the nickel sulfate 6 hydrate, the cobalt sulfate 5 hydrate, and the aluminum nitrate were utilized in a weight of 20 wt % based on the total weight of the mixed aqueous solution. In addition, the nickel sulfate 6 hydrate, the cobalt sulfate 5 hydrate, and the aluminum nitrate were mixed in a mole ratio of 80:15:5=Ni:Co:Al.

On the other hand, 500 ml of ion exchange water was added to a reaction layer (e.g., a reactor) and maintained at 50° C. Subsequently, the ion exchange water was bubbled by nitrogen gas, and oxygen dissolved therein was removed. Then, the above mixed aqueous solution was added to the ion exchange water in a dropwise fashion, while the ion exchange water in the reaction layer was agitated and maintained at 50° C. In addition, a saturated NaOH aqueous solution in an excessive amount based on Ni, Co, and Al in the mixed aqueous solution (e.g., the mole amount of NaOH is greater than the sum of the mole amount of Ni, Co and Al in the mixed aqueous solution) was added to the ion exchange water in a dropwise fashion. During the addition, the reaction layer aqueous solution was maintained at a pH of 11.5 and 50° C. The mixed aqueous solution and the saturated NaOH aqueous solution were added at a speed of 3 ml/min for 10 hours and agitated at a speed of 4 to 5 m/s. Accordingly, hydroxide salt of each metal atom was co-precipitated.

Next, the resultant was solid-liquid separated, for example, suction-filtered to take (e.g., separate) the co-precipitated hydroxide salt from the reaction layer aqueous solution, and the co-precipitated hydroxide salt was cleaned (e.g., rinsed) with ion exchange water. Subsequently, the co-precipitated hydroxide salt was vacuum-dried, for example, at about 100° C. for 10 hours.

The dried co-precipitated hydroxide salt was ground with a mortar and a pestle for a set number (e.g., a couple) of minutes to obtain a dried powder, and the dried powder was mixed with lithium hydroxide (LiOH), thus obtaining a mixed powder. Herein, a mole ratio of Li with Ni, Co, and M (Ni+Co+M=Me), that is, a mole ratio of Li and Me (Li:Me), may be about 0.96:1.

Subsequently, the mixed powder was fired at 700° C. to 800° C. for 10 hours, thereby complete the manufacturing of a lithium nickel-based oxide, that is, Li_{0.96}Ni_{0.8}Co_{0.15}Al_{0.05}O₂.

The lithium nickel-based oxide had an average particle diameter (D50) of 7 μm when measured utilizing a laser diffraction scattering-type particle distribution meter (Microtrac MT3000, Nikkiso Co., Ltd.). Herein, the average particle diameter (D50) indicates a particle diameter having a cumulative value of 50% in a particle diameter distribution when a secondary particle of the lithium nickel-based oxide was regarded as having a globular shape.

### Preparation Example 2

A lithium nickel-based oxide, that is, Li_{0.96}Ni_{0.8}Co_{0.15}Mn_{0.05}O₂ was manufactured according to substantially the same method as Preparation Example 1 except for utilizing manganese sulfate 7 hydrate instead of the aluminum nitrate. The lithium nickel-based oxide had an average particle diameter (D50) of 7 μm.

### Preparation of Positive Active Material

### Example 1

Diamond-like carbon (DLC) was deposited on the surface of the lithium nickel-based oxide particle 22b obtained in Preparation Example 1 utilizing a plasma chemical vapor growth (CVD) method. The plasma chemical vapor growth (CVD) method may be performed utilizing NANOCOAT-1000 (NanoTech Corporation.).

For example, the lithium nickel-based oxide particles and a holder on which a silicon substrate as a reference was laid out were set in a chamber and ion impact-treated for 3 minutes. Subsequently, argon gas (carrier gas) and acetylene gas (a raw material gas) were introduced into the chamber, while the holder was heated at 200° C. Then, the acetylene gas was made into the plasma state and reacted in a gas phase. Subsequently, the diamond-like carbon (DLC) produced through the reaction was deposited on the surface of the lithium nickel-based oxide particle 22b and the silicon substrate to prepare a positive active material having a coating layer on the surface of the lithium nickel-based oxide particle.

Herein, the argon gas and the acetylene gas were set to have an entire (total) pressure of 0.6 Pa, and the argon gas was set at a flow rate of 10 sccm, while the acetylene gas was set at a flow rate of 150 sccm. The treatment time was set to form a coating layer with an average thickness of 5 nm on the positive active material particles.

### Evaluation 1: Thickness of Coating Layer

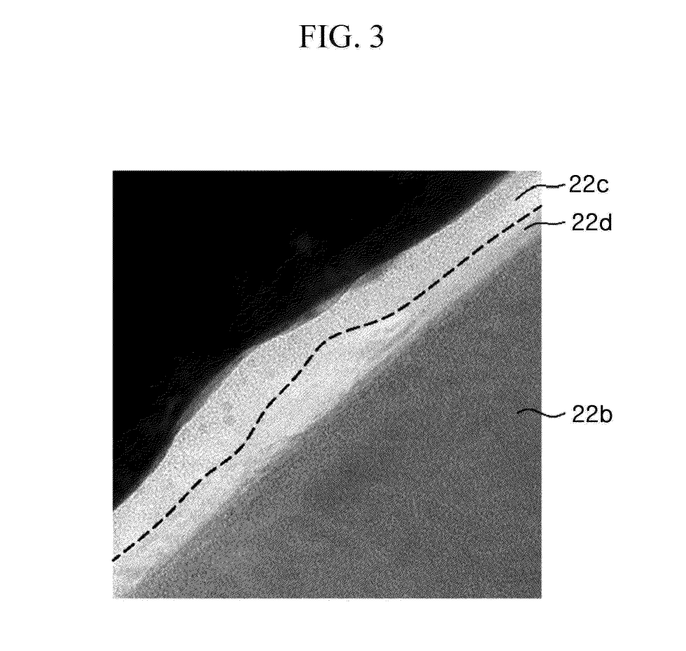

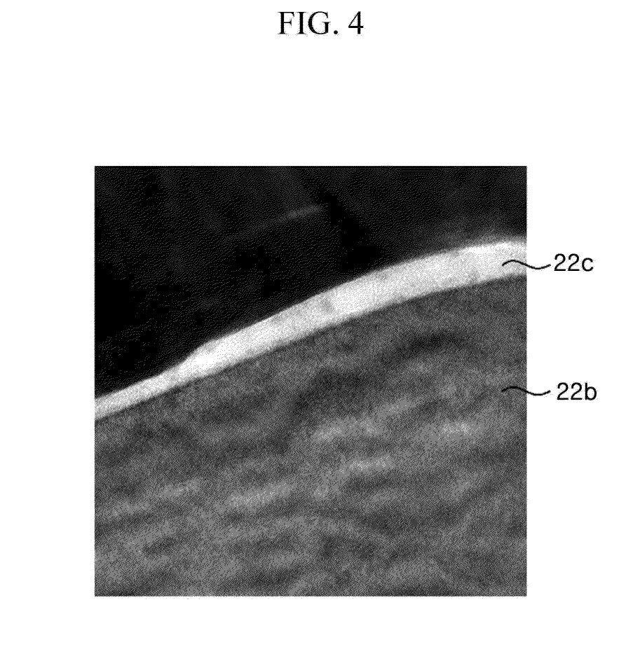

The average thickness of the coating layers was measured. FIGS. 3 and 4 show the TEM (Transmission Electron Microscope) photographs of the coating layer 22c.

These photographs were (e.g., FIG. 4 was) provided with 1,000,000 times magnification, and FIG. 3 is produced by further magnifying FIG. 4.

Referring to FIG. 3, a region 22d was shown to have a layer structure, but this layer structure was formed by a positive active material component. Referring to FIGS. 3 and 4, the coating layer 22c had a thickness ranging from 2.6 nm to 5.1 nm.

Accordingly, the sample (the DLC deposited on the surface of the positive active material particle 22b and the silicon substrate) formed on the holder was utilized to measure the HR-RBS and HR-ERDA, to be described in more detail later.

Evaluation 2: Measurement of SP²/SP³ Ratio of Coating Layer

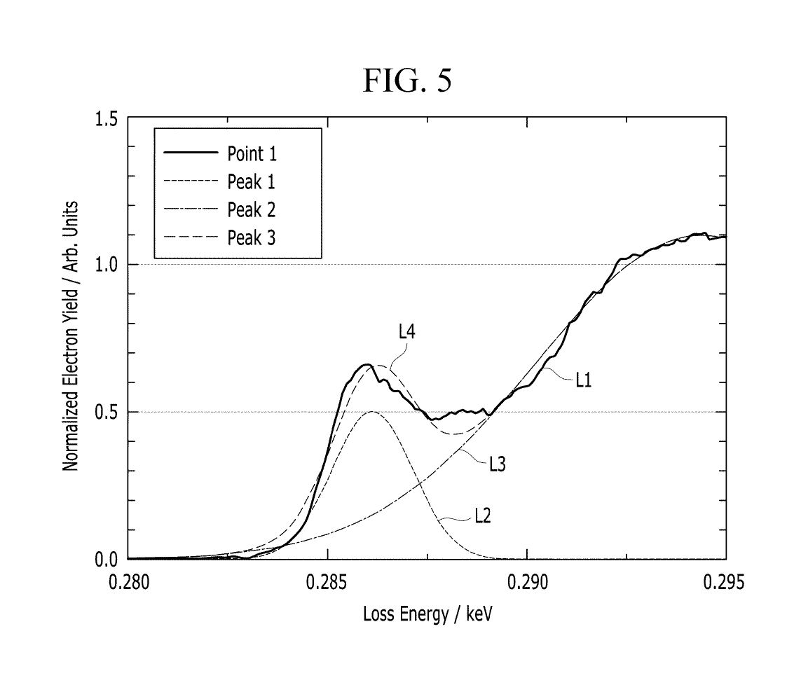

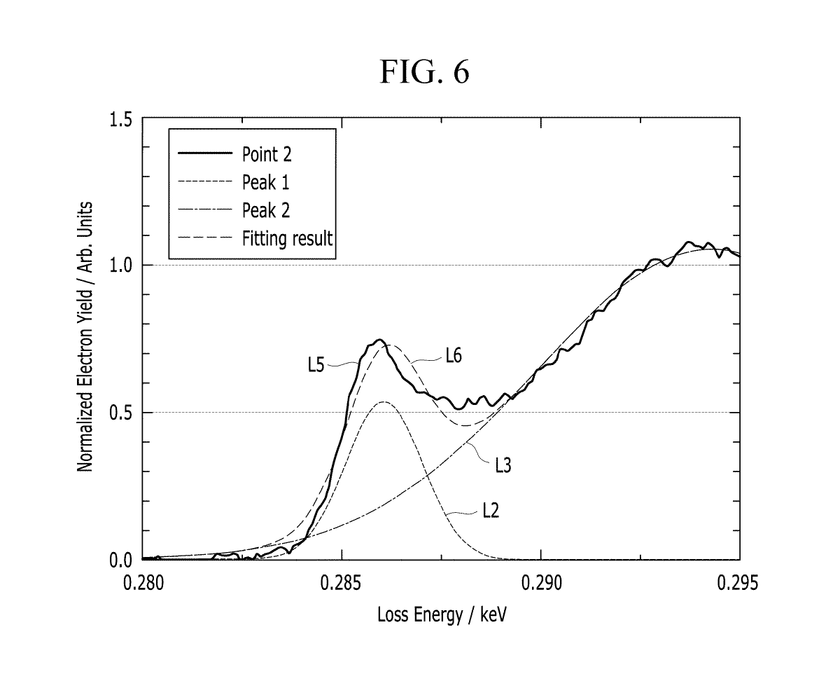

The SP²/SP³ ratio of the positive active material according to Example 1 was measured utilizing an electron energy loss spectroscopy (EELS). The EELS was performed utilizing a coaxial cylindrical mirror analyzer (CMA) (PerkinElmer Inc.) attached to a PHI4300 scanning Auger electron spectroscope to measure the SP²/SP³ ratio in the aforementioned method. Herein, referring to FIGS. 5 and 6, a method of measuring an SP²/SP³ in each measuring region (a measuring point) is illustrated.

FIGS. 5 and 6 are graphs showing the measurement results of the positive active material according to Example 1 utilizing the electron energy loss spectroscopy (EELS).

In FIGS. 5 and 6, a horizontal axis indicates an energy loss amount, and a vertical axis indicates a standardized electron yield.

In FIG. 5, a graph L1 shows a measurement result at a measuring region (Point1), a graph L2 shows a measurement result of graphite, and a graph L3 shows a measurement result of diamond.

The atom % of SP² carbon atom in the graphite was 100 atom %, and the atom % of SP³ carbon atom in the diamond was 100 atom %. The SP² carbon atom and SP³ carbon atom are present with an SP²/SP³ ratio at Point 1. Accordingly, the graph L1 may be regarded as a sum of the product of multiplying a respective coefficient with each graph L2 and L3 (where the sum of the coefficient for graph L2 and the coefficient for graph L3 equals 1). Accordingly, a combination graph obtained by multiplying a respective coefficient with each graph L2 and L3 was compared with the graph L1.

The treatment was repeated by changing the coefficient to find a combination graph closest to the graph L1 (hereinafter, referred to as a “fitting graph”).

A graph L4 indicates the fitting graph. A coefficient when the fitting graph was obtained indicates an SP²/SP³ ratio. In other words, the SP²/SP³ at Point 1 was obtained by dividing the coefficient multiplied with the graph L2 by the coefficient multiplied with the graph L3. The SP²/SP³ ratio at Point 1 was 51/49.

FIG. 6 shows the same as FIG. 5.

In FIG. 6, a graph L5 shows a measurement result at Point 2 utilizing EELS. A graph L6 is a fitting graph corresponding to Point 2. Referring to FIG. 6, an SP²/SP³ ratio at Point 2 is 55/45.

### Evaluation 3: Atom % Measurement of Hydrogen Atom in Coating Layer

The atom % of a hydrogen atom in a coating layer was measured utilizing both High-Resolution Rutherford Backscattering Spectrometry (HR-RBS) and High-Resolution Elastic Recoil Detection Analysis (HR-ERDA). Herein, a measuring apparatus may be a RBS analysis apparatus HRBS500 made by Kobe Steel, Ltd. As described above, a sample for the measurement was formed in a holder utilizing plasma CVD. Tables 1 and 2 describe conditions for the measurement by RBS and ERDA.

TABLE 1

| RBS | |
|---|---|
| measurement condition | Parameter |
| Energy of incident ion | 450 keV |
| Ion | He⁺ |
| Scattering angle | 57° |
| Incident angle | 45° from a normal or perpendicular line on the |
| | surface of sample (e.g., a line normal or |
| | perpendicular to the surface of the sample) |
| Sample current | 25 nA |
| Dosage | 40 μC |

TABLE 2

| ERDA | |
|---|---|
| measurement condition | Parameter |
| Energy of incident ion | 480 keV |
| Ion | N₂⁺ |
| Scattering angle | 30° |
| Incident angle | 70° from a normal or perpendicular line on the |
| | surface of sample (e.g., a line normal or |
| | perpendicular to the surface of the sample) |
| Sample current | about 2 nA |
| Dosage | about 0.4 μC |

In other words, in the RBS, He⁺ ions were radiated onto a sample under the aforementioned condition as shown in Table 1, and the scattered He ions were detected at a scattering angle of 57° by a magnetic deflection energy analyzer.

In addition, in the ERDA, N₂⁺ ions were radiated onto a sample under the aforementioned condition as shown in Table 2, and the reflected N₂⁺ ions were detected at a scattering angle of 30° by a magnetic direction energy analyzer.

On the other hand, the dosage was calculated by vibrating a pendulum in a beam passage and measuring a current amount radiated from the pendulum.

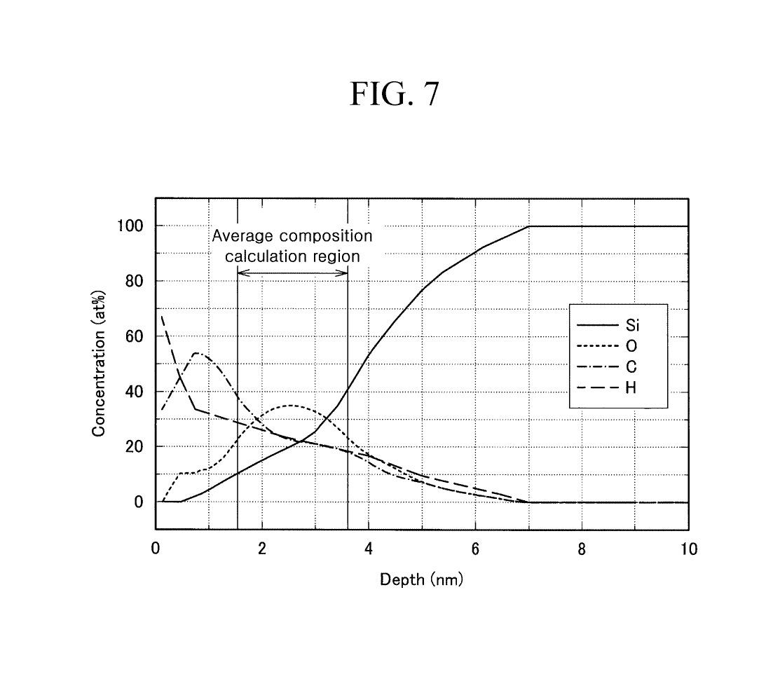

According to the RBS and the ERDA, a correlation between a depth from the surface of the sample and the surface density (e.g., concentration on the surface) (atom %) of each element (C, O, Si, and H) is provided in FIG. 7.

FIG. 7 is a graph showing the measurement results about the coating layer of the positive active material according to Example 1 utilizing High-Resolution Rutherford Backscattering Spectrometry (HR-RBS) and High-Resolution Elastic Recoil Detection Analysis (HR-ERDA).

In FIG. 7, a horizontal axis indicates a depth from the surface of a sample to the measuring surface (e.g., the surface where the measurement took place), while a vertical axis indicates the atom % of each element on the measuring surface, that is, surface density. The atom % of each element indicates (e.g., represents) a ratio of the number of atoms of each element based on (versus) the total number of the atoms of all the elements. In the present Example, a depth ranging from 1.6 nm to 3.6 nm may be defined as an average composition calculation region. In addition, the atom % of hydrogen in DLC was calculated by measuring the number of hydrogen atoms in the average composition calculation region and the total number of all the atoms in the corresponding region and then, dividing the number of hydrogen atoms by the total number of all the atoms.

Referring to FIG. 7, the atom % of hydrogen in Example 1 may be about 24 atom %.

### Manufacture of Coin Half Cell

The positive active material, acetylene black, and polyvinylidene fluoride were mixed in a weight ratio of 95:2:3 and then, dispersed into N-methyl-2-pyrrolidone, thus preparing a slurry. The slurry was coated on an aluminum foil at a dew point temperature of less than or equal to −40° C. under a dry environment and dried to form a positive active material layer. The positive active material layer was compressed to be 50 μm thick, thereby complete the manufacturing of a positive electrode.

A negative electrode was manufactured by coating a metal lithium thin film on a copper foil.

As for a separator, a 12 μm-thick porous polypropylene film was interdisposed between the positive and negative electrodes, thus forming an electrode structure.

Subsequently, the electrode structure was processed into a coin half cell size and housed in a coin half cell container. An electrolyte solution was prepared by mixing ethylene carbonate and dimethyl carbonate in a volume ratio of 3:7 to obtain a non-aqueous solvent and dissolving hexafluoro lithium phosphate at a concentration of 1.3 mol/L therein. Then, the electrolyte solution was injected into the coin half cell and thus impregnated into the separator, thereby complete the manufacturing of a half cell according to Example 1.

### Evaluation 3: Measurement of Rate Characteristics

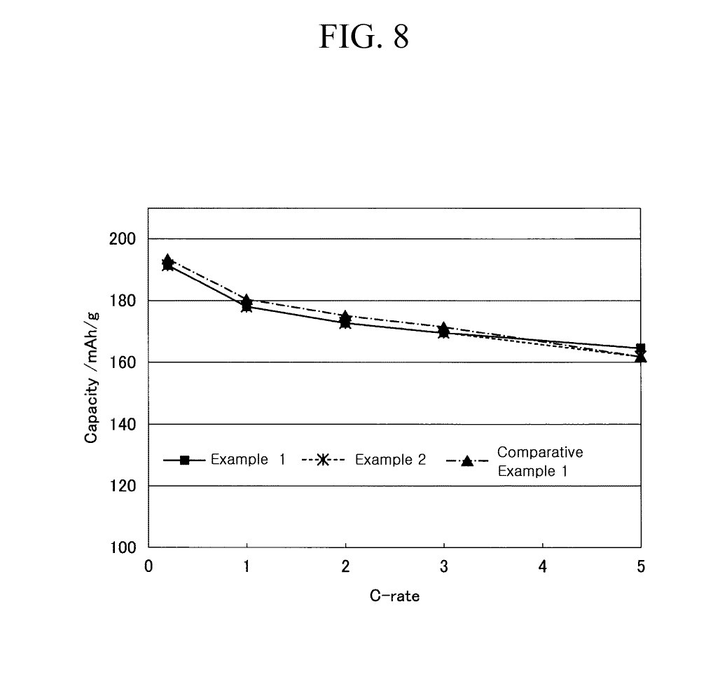

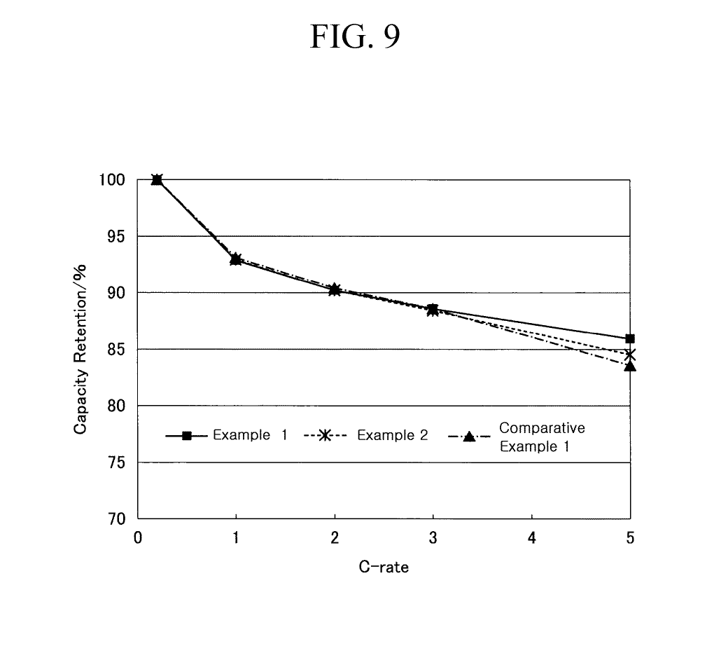

The half cells were charged and discharged at the charge and discharge rate with a cut-off voltage provided in Table 3. In other words, the half cells were charged and discharged at a different rate in each charge and discharge cycle. The charge and discharge were performed at 45° C. Then, discharge capacity at each cycle was measured. The results are provided in Table 5 and FIGS. 8 and 9.

In addition, capacity retention at each discharge rate was calculated by standardizing discharge capacity at the 3rd to 6th cycle with discharge capacity at the 2nd cycle (e.g., dividing the discharge capacity at each of the 3rd to 6th cycle with the discharge capacity at the 2nd cycle).

FIG. 8 is a graph showing capacity relative to a rate of charging the rechargeable lithium battery cells according to Examples 1 and 2 and Comparative Example 1, and FIG. 9 is a graph showing capacity retention relative to a rate of charging the rechargeable lithium battery cells according to Examples 1 and 2 and Comparative Example 1.

TABLE 3

| Test cycle | Charge rate | Discharge rate | Cut off voltage |
|---|---|---|---|
| 1 | 0.1 CC-CV | 0.1 CC | 4.3 V-2.8 V |
| 2 | 0.2 CC-CV | 0.2 CC | 4.3 V-2.8 V |
| 3 | 0.2 CC-CV | 1.0 CC | 4.3 V-2.8 V |
| 4 | 0.2 CC-CV | 2.0 CC | 4.3 V-2.8 V |
| 5 | 0.2 CC-CV | 3.0 CC | 4.3 V-2.8 V |
| 6 | 0.2 CC-CV | 5.0 CC | 4.3 V-2.8 V |

### Manufacture of Pouch Full Cell

The positive active material, acetylene black, and polyvinylidene fluoride were mixed in a weight ratio of 95:2:3, and then, dispersed into N-methyl-2-pyrrolidone, thus preparing a slurry.

Then, the slurry was coated on an aluminum thin film at a dew point temperature of less than or equal to −40° C. under a dry environment to form a positive active material layer, thus complete the manufacturing of a positive electrode.

In addition, graphite was utilized as a negative electrode.

As for a separator, a 12 μm-thick porous polypropylene film was coated with a coating solution obtained by mixing Mg(OH)₂ and polyvinylidene fluoride (PVdF) in a weight ratio of 70:30 to form a coating layer. Herein, the coating layer was 2 μm thick.

This separator was interdisposed between the positive and negative electrodes to manufacture an electrode structure. Subsequently, the electrode structure was processed to be acceptable into (suitable for) a pouch full cell and inserted into a pouch full cell. On the other hand, an electrolyte solution was prepared by mixing ethylene carbonate and dimethyl carbonate in a volume ratio of 3:7 to prepare a non-aqueous solvent and dissolving hexafluorolithium phosphate (LiPF₆) at a concentration of 1.3 mol/L therein. The electrolyte solution was injected into the pouch full cell and impregnated into the separator. Accordingly, a pouch full cell according to Example 1 was manufactured.

### Evaluation 5: Measurement of Cycle-Life Characteristics

The pouch full cells were charged and discharged at a discharge rate and a cut-off voltage provided in Table 4. In other words, the charge and discharge were performed by changing a charge and discharge rate at every number of a set or predetermined charge and discharge cycle. The charge and discharge were performed at 45° C. The results are provided in Table 4.

TABLE 4

| Test cycle | Charge rate | Discharge rate | Cut off voltage |
|---|---|---|---|
| 1 | 0.2 CC-CV | 0.2 CC | 4.2 V-2.5 V |
| 1 | 1.0 CC-CV | 1.0 CC | 4.2 V-2.5 V |
| 98 | 1.0 CC-CV | 1.0 CC | 4.2 V-2.5 V |
| 1 | 0.2 CC-CV | 0.2 CC | 4.2 V-2.5 V |
| 99 | 1.0 CC-CV | 1.0 CC | 4.2 V-2.5 V |
| 1 | 0.2 CC-CV | 0.2 CC | 4.2 V-2.5 V |
| 98 | 1.0 CC-CV | 1.0 CC | 4.2 V-2.5 V |
| 1 | 1.0 CC-CV | 1.0 CC | 4.2 V-2.5 V |
| 1 | 0.2 CC-CV | 0.2 CC | 4.2 V-2.5 V |

In addition, capacity retention was obtained by dividing the discharge capacity at the 300th cycle by the discharge capacity at the 2^{nd} cycle.

### Evaluation 6: Measurement of Surface State of Positive Active Material

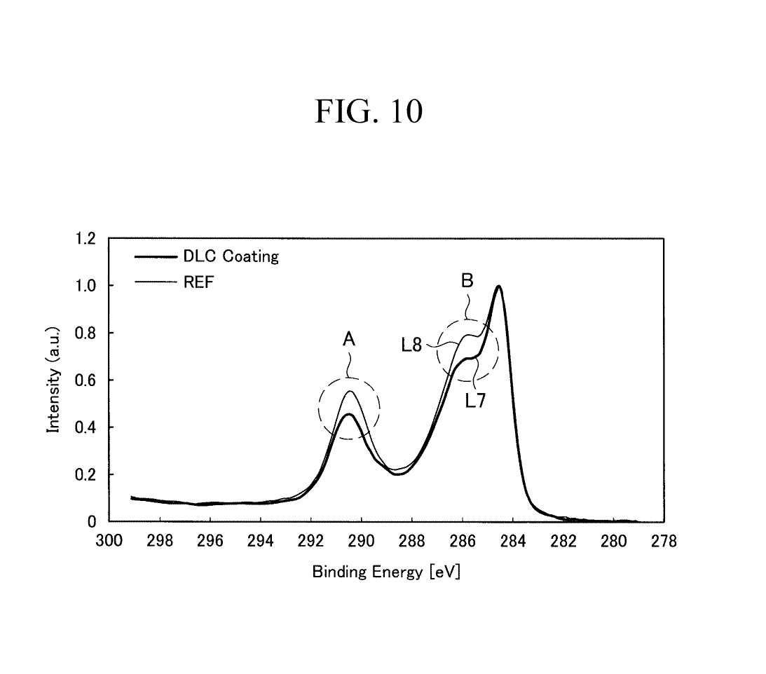

After the cycle characteristics evaluation, the pouch full cell was decomposed (dissembled) to take out the positive active material layer therein, and the positive active material layer was XPS-analyzed to evaluate the surface state of the positive active material, for example, the state of the electrolyte solution attached to the surface of the positive active material. The results are provided in FIGS. 10 to 13.

The XPS analysis was performed utilizing Quantera SXM made by ULVAC-PHI, Inc. In addition, an excited X-ray was a monochromatic Al K 1,2 ray (1486.6 eV), and herein, the diameter of the X-ray was set to be 200 μm, and the escape angle of photoelectrons was set at 45° (slope of a detector with the surface of a sample).

FIGS. 10 to 13 are graphs showing the measurement results of the surface of the positive active material by X-ray photoelectron spectroscopy (XPS).

In FIGS. 10 to 13, a horizontally axis indicates the binding energy, while a vertical axis indicates the intensity. A graph L7 shows the measurement result of Example 1, and a graph L8 shows the measurement result of Comparative Example 1.

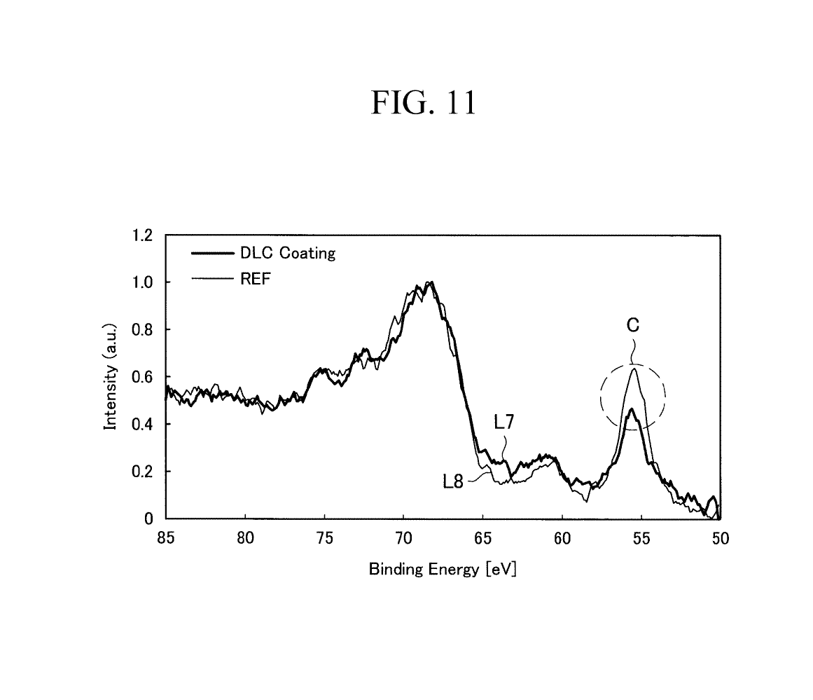

A peak A shown in FIG. 10 corresponds to carbonate lithium and carbonate ester, and a peak B corresponds to carbonate ester. A peak C shown in FIG. 11 corresponds to carbonate lithium.

When a peak is lower, a smaller amount of a material corresponding to the peak is utilized. The carbonate lithium and the carbonate ester are produced by decomposition of the electrolyte solution or a reaction of the highly nickel-based composite oxide with moisture or carbon dioxide. Accordingly, as a peak is lower, a side reaction, particularly, the decomposition of the electrolyte solution is suppressed.

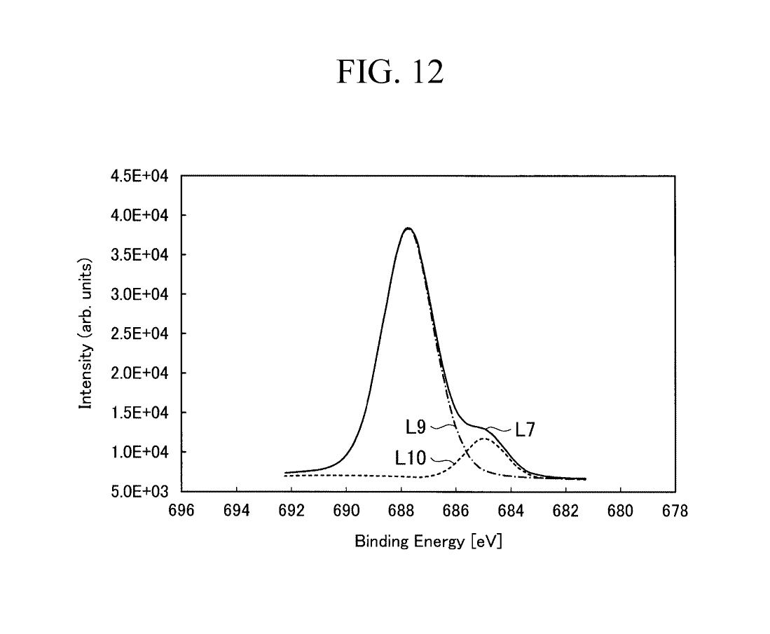

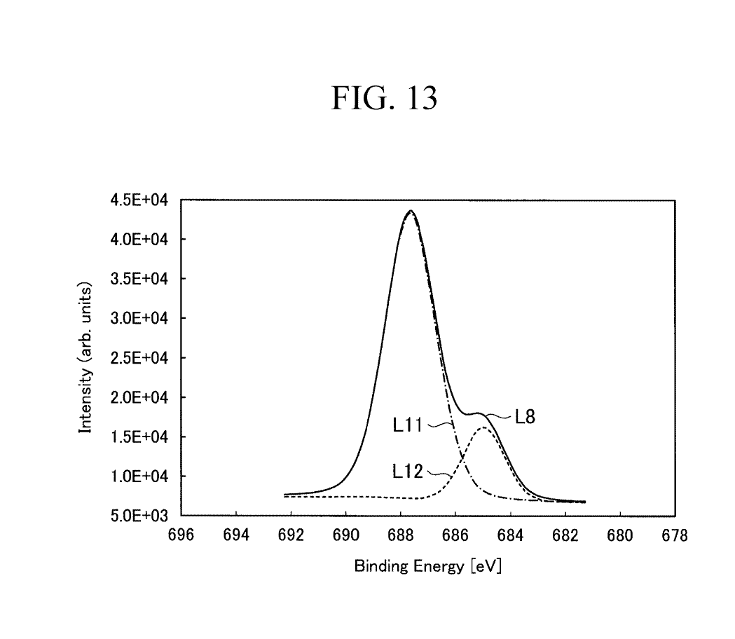

In FIG. 12, graphs L9 and L10 are obtained by peak-separating the graph L7 of Example 1. The graphs L11 and L12 in FIG. 13 are obtained by peak-separating the graph L8 of Comparative Example 1. The graphs L9 and L11 correspond to a F—C bond, that is, a solvent in the electrolyte solution.

The graphs L10 and L12 correspond to a fluorine ion. The fluorine ion is produced by the decomposition of the electrolyte solution. Accordingly, a ratio of the electrolyte solution was obtained by dividing a peak in the graph L10 by a peak in the graph L9.

Likewise, a ratio of the electrolyte solution was obtained by dividing a peak in the graph L12 by a peak in the graph L11.

As clarified from (shown in) FIGS. 12 and 13, a value obtained by dividing the peak of the graph L10 by the peak of the graph L9 is smaller than a value obtained by dividing the peak of the graph L12 by the peak of the graph L11.

Based on the results, the side reaction of the positive active material particles, and for example, the decomposition of the electrolyte solution in Example 1, was better suppressed than in Comparative Example 1.

The same result was obtained in other Examples.

Accordingly, one reason that each of the Examples showed excellent cycle characteristics is that a side reaction was suppressed by a coating layer.

In addition, since each of the Examples showed clearly (significantly) improved cycle characteristics, the oxidation reaction of Ni on the surface of positive active material particles was suppressed by a coating layer.

### Examples 2 to 12 and Comparative Examples 1 to 4

Each positive active material according to Examples 2 to 12 and Comparative Examples 1 to 4 was treated the same as that of Example 1 except for changing a kind of the lithium nickel-based oxide particles, if DLC was coated or not, and/or a condition in plasma CVD. The results are provided in Table 5.

In Examples 9 to 12, acetylene gas was utilized as raw gas in the plasma CVD method.

In Table 5, the discharge capacity indicates discharge capacity at the second cycle in the measurement of rate characteristics.

TABLE 5

| | | Average | | | Introduced | | Rate | |
|---|---|---|---|---|---|---|---|---|
| | | particle | DLC | | hydrogen | Discharge | characteristics | Cycle |
| | Lithium nickel-based | diameter D50 | thickness | SP²/SP³ | amount | capacity | 5 C./0.2 C. | characteristics |
| | oxide particle | (μm) | (nm) | ratio | (atom %) | (mAh/g) | (%) | (%) |
| Example 1 | Li_{0.96}Ni_{0.8}Co_{0.15}Al_{0.05}O₂ | 7 | 5 | 55/45 | 24 | 191 | 85.9 | 88 |
| Example 2 | Li_{0.96}Ni_{0.8}Co_{0.15}Al_{0.05}O₂ | 7 | 5 | 60/40 | 24 | 191 | 84.5 | 92 |
| Example 3 | Li_{0.96}Ni_{0.8}Co_{0.15}Mn_{0.05}O₂ | 7 | 5 | 55/45 | 24 | 202 | 86.2 | 92 |
| Example 4 | Li_{0.96}Ni_{0.8}Co_{0.15}Mn_{0.05}O₂ | 7 | 5 | 60/40 | 24 | 202 | 85.3 | 96 |
| Example 5 | Li_{0.96}Ni_{0.8}Co_{0.15}Al_{0.05}O₂ | 7 | 20 | 55/45 | 24 | 189 | 86.5 | 86 |
| Example 6 | Li_{0.96}Ni_{0.8}Co_{0.15}Al_{0.05}O₂ | 7 | 20 | 60/40 | 24 | 189 | 85 | 90 |
| Example 7 | Li_{0.96}Ni_{0.8}Co_{0.15}Mn_{0.05}O₂ | 7 | 20 | 55/45 | 24 | 200 | 86.7 | 90 |
| Example 8 | Li_{0.96}Ni_{0.8}Co_{0.15}Mn_{0.05}O₂ | 7 | 20 | 60/40 | 24 | 200 | 85.7 | 94 |
| Example 9 | Li_{0.96}Ni_{0.8}Co_{0.15}Al_{0.05}O₂ | 7 | 5 | 55/45 | 2 | 191 | 85.9 | 89 |
| Example 10 | Li_{0.96}Ni_{0.8}Co_{0.15}Al_{0.05}O₂ | 7 | 5 | 60/40 | 2 | 191 | 84.5 | 93 |
| Example 11 | Li_{0.96}Ni_{0.8}Co_{0.15}Mn_{0.05}O₂ | 7 | 5 | 55/45 | 2 | 202 | 86.2 | 93 |
| Example 12 | Li_{0.96}Ni_{0.8}Co_{0.15}Mn_{0.05}O₂ | 7 | 5 | 60/40 | 2 | 202 | 85.3 | 97 |
| Comparative | Li_{0.96}Ni_{0.8}Co_{0.15}Al_{0.05}O₂ | 7 | 0 | — | — | 193 | 83.6 | 82 |
| Example 1 | | | | | | | | |
| Comparative | Li_{0.96}Ni_{0.8}Co_{0.15}Mn_{0.05}O₂ | 7 | 0 | — | — | 204 | 82.4 | 86 |
| Example 2 | | | | | | | | |
| Comparative | Li_{0.96}Ni_{0.8}Co_{0.15}Al_{0.05}O₂ | 7 | 20 | 30/70 | 24 | 189 | 83.2 | 84 |
| Example 3 | | | | | | | | |
| Comparative | Li_{0.96}Ni_{0.8}Co_{0.15}Mn_{0.05}O₂ | 7 | 20 | 30/70 | 24 | 200 | 82.4 | 85 |
| Example 4 | | | | | | | | |

Referring to Table 5, all the Examples showed excellent cycle-life characteristics at a high temperature.

In addition, referring to Table 5 and FIGS. 8 and 9, a half cell according to Examples of the present invention exhibited excellent load characteristics at a temperature (e.g., a high temperature) and a high rate compared with a half cell according to Comparative Example.

Accordingly, as shown in Examples of the present invention, a rechargeable lithium battery cell according to Examples of the present invention was suppressed from a side reaction by a highly nickel-based composite oxide and furthermore, showed an improved cycle-life.

Expressions such as “at least one of,” when preceding a list of elements, modify the entire list of elements and do not modify the individual elements of the list. Further, the use of “may” when describing embodiments of the inventive concept refers to “one or more embodiments of the inventive concept.” Also, the term “exemplary” is intended to refer to an example or illustration.

As used herein, the term “substantially,” “about,” and similar terms are used as terms of approximation and not as terms of degree, and are intended to account for the inherent deviations in measured or calculated values that would be recognized by those of ordinary skill in the art. Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A positive active material for a rechargeable lithium battery, comprising
a lithium nickel-based oxide particle; and
a coating layer surrounding the lithium nickel-based oxide particle, the coating layer comprising diamond-like carbon (DLC),
wherein the lithium nickel-based oxide particle comprises lithium, and a nickel-containing metal, the nickel-containing metal comprises about 60 atom % or greater of nickel based on a total atomic amount of the nickel-containing metal, and
an SP²/SP³ ratio of the coating layer is about 50/50 to about 60/40.

2. The positive active material for a rechargeable lithium battery of claim 1, wherein a thickness of the coating layer is about 2 nm to about 20 nm.

3. The positive active material for a rechargeable lithium battery of claim 1, wherein the lithium nickel-based oxide particle comprises about 80 atom % or greater of nickel based on the total atomic amount of the nickel-containing metal.

4. The positive active material for a rechargeable lithium battery of claim 1, wherein the coating layer comprises about 2 atom % to about 30 atom % of hydrogen based on a total atomic amount of the coating layer.

5. The positive active material for a rechargeable lithium battery of claim 1, wherein the lithium nickel-based oxide particle is represented by Chemical Formula 1:
LiₐNiₓCo_{y}M_{z}O₂ Chemical Formula 1
wherein,
M is at least one metal selected from aluminum (Al), manganese (Mn), chromium (Cr), iron (Fe), vanadium (V), magnesium (Mg), titanium (Ti), zirconium (Zr), niobium (Nb), molybdenum (Mo), tungsten (W), copper (Cu), zinc (Zn), gallium (Ga), indium (In), tin (Sn), lanthanum (La), and cerium (Ce);
0.2≦a≦1.2, 0.8≦x<1, 0<y≦0.2, 0≦z≦0.1, and x+y+z=1.

6. The positive active material for a rechargeable lithium battery of claim 1, wherein the coating layer is formed by a plasma chemical vapor growth (CVD) method, a physical vapor growth (PVD) method, a plasma based ion implantation (PBII) method or a combination thereof on a surface of the lithium nickel-based oxide particle.

7. A positive active material layer for a rechargeable lithium battery comprising the positive active material of claim 1.

8. A rechargeable lithium battery comprising the positive active material layer of claim 7.

9. The positive active material layer of claim 7, wherein a thickness of the coating layer is about 2 nm to about 20 nm.

10. The positive active material layer of claim 7, wherein the lithium nickel-based oxide particle comprises about 80 atom % or greater of nickel based on the total atomic amount of the nickel-containing metal.

11. The positive active material layer of claim 7, wherein the coating layer comprises about 2 atom % to about 30 atom % of hydrogen based on a total atomic amount of the coating layer.

12. The positive active material layer of claim 7, wherein the lithium nickel-based oxide particle is represented by Chemical Formula 1:
LiₐNiₓCo_{y}M_{z}O₂ Chemical Formula 1
wherein,
M is at least one metal selected from aluminum (Al), manganese (Mn), chromium (Cr), iron (Fe), vanadium (V), magnesium (Mg), titanium (Ti), zirconium (Zr), niobium (Nb), molybdenum (Mo), tungsten (W), copper (Cu), zinc (Zn), gallium (Ga), indium (In), tin (Sn), lanthanum (La), and cerium (Ce);
0.2≦a≦1.2, 0.8≦x<1, 0<y≦0.2, 0≦z≦0.1, and x+y+z=1.

13. The positive active material layer of claim 7, wherein the coating layer is formed by a plasma chemical vapor growth (CVD) method, a physical vapor growth (PVD) method, a plasma based ion implantation (PBII) method or a combination thereof on a surface of the lithium nickel-based oxide particle.

14. The rechargeable lithium battery of claim 8, wherein a thickness of the coating layer is about 2 nm to about 20 nm.

15. The rechargeable lithium battery of claim 8, wherein the lithium nickel-based oxide particle comprises about 80 atom % or greater of nickel based on the total atomic amount of the nickel-containing metal.

16. The rechargeable lithium battery of claim 8, wherein the coating layer comprises about 2 atom % to about 30 atom % of hydrogen based on a total atomic amount of the coating layer.

17. The rechargeable lithium battery of claim 8, wherein the lithium nickel-based oxide particle is represented by Chemical Formula 1:
LiₐNiₓCo_{y}M_{z}O₂ Chemical Formula 1
wherein,
M is at least one metal selected from aluminum (Al), manganese (Mn), chromium (Cr), iron (Fe), vanadium (V), magnesium (Mg), titanium (Ti), zirconium (Zr), niobium (Nb), molybdenum (Mo), tungsten (W), copper (Cu), zinc (Zn), gallium (Ga), indium (In), tin (Sn), lanthanum (La), and cerium (Ce);
0.2≦a≦1.2, 0.8≦x<1, 0<y≦0.2, 0≦z≦0.1, and x+y+z=1.

18. The rechargeable lithium battery of claim 8, wherein the coating layer is formed by a plasma chemical vapor growth (CVD) method, a physical vapor growth (PVD) method, a plasma based ion implantation (PBII) method or a combination thereof on a surface of the lithium nickel-based oxide particle.
